(19) United States
(12) Patent Application Publication
(10) Pub. No.: US 2013/0152415 A1
(43) Pub. Date: Jun. 20, 2013

(54) MEASURING DEVICE

(71) Applicants: WEN-MING YI, Wuhan City (CN); CONG-XU HU, Wuhan City (CN); XIAO-LI LIU, Wuhan City (CN); YU-LIN LIU, Wuhan City (CN)

(72) Inventors: WEN-MING YI, Wuhan City (CN); CONG-XU HU, Wuhan City (CN); XIAO-LI LIU, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/567,212

(22) Filed: Aug. 6, 2012

(30) Foreign Application Priority Data
Dec. 15, 2011 (CN) 201110420309.2

(51) Int. Cl. G01B 5/02

(52) U.S. Cl. 33/438; 33/483

(57) ABSTRACT

A measuring device includes a bracket, a sliding ruler, a securing assembly, and a driving assembly. The bracket includes a first set of scale lines. The sliding ruler is slidably attached to the bracket and includes a second set of scale lines. The securing assembly includes a securing member and a resilient member mounted to the securing member. The driving assembly is rotatably attached to the bracket and includes a handle and a gear secured to the handle. The gear is rotatable to slide the sliding ruler relative to the bracket; the securing member is secured to the bracket, and the resilient member is secured between the sliding ruler and the bracket, to prevent the sliding ruler from sliding relative to the bracket.

### BACKGROUND

1. Technical Field

The present disclosure relates to measuring devices, and particularly to a height measuring device.

2. Description of Related Art

In some tests, such as a noise power test, a plurality of microphones are placed on different positions, which have different heights from a ground. In a noisy laboratory, a ruler is used to measure the different heights and point different positions corresponding to each height. However, when the height is higher than a range of the ruler, one more ruler is used, which is inconvenient. Therefore, an improved measuring device may be desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a measuring device.

FIG. 2 is an assembled, isometric view of the measuring device of FIG. 1.

FIG. 3 is similar to FIG. 2, but viewed from a different aspect.

FIG. 4 is a top view of the measuring device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

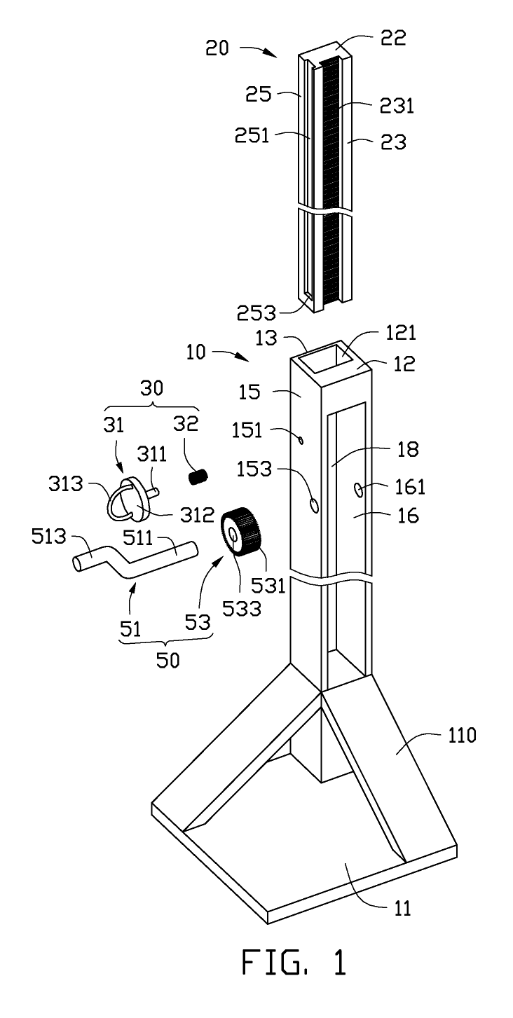

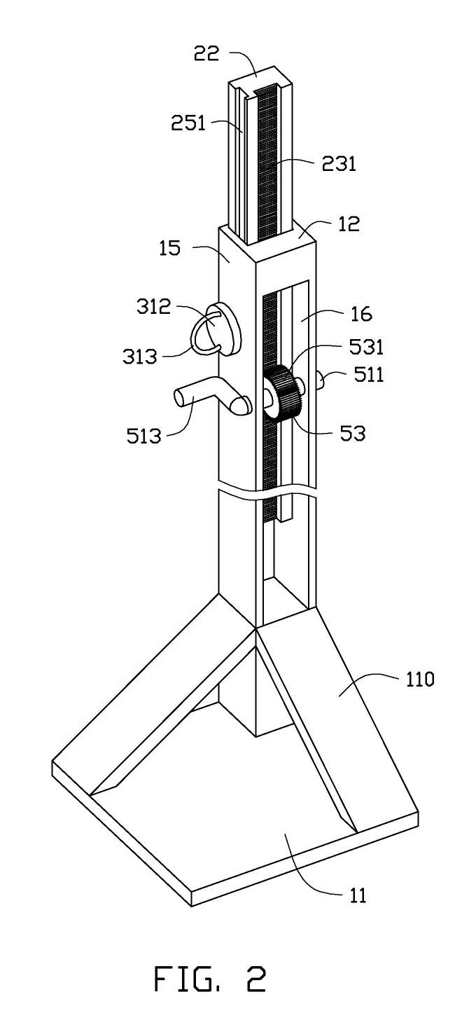

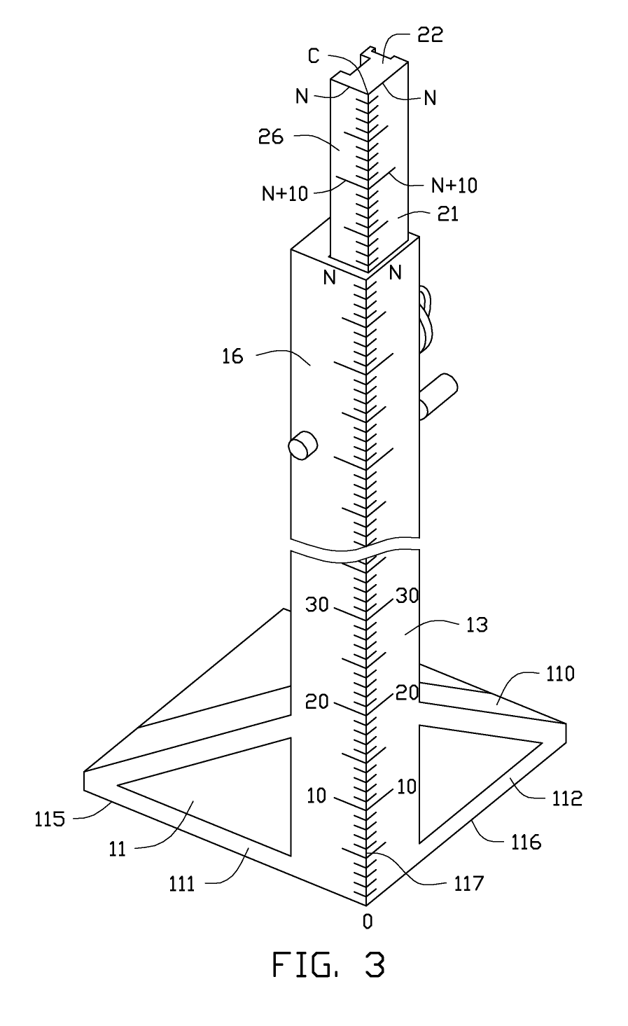

FIGS. 1-3 show a measuring device in accordance with an embodiment. The measuring device includes a bracket 10, a sliding ruler 20, a securing assembly 30, and a driving assembly 50.

The bracket 10 includes a base 11, a top plate 12, a rear plate 13, a first side plate 15, and a second side plate 16 opposite to the first side plate 15. In one embodiment, the base 11 is substantially parallel to the top plate 12 and substantially perpendicular to the rear plate 13, the first side plate 15 and the second side plate 16, and the rear plate 13 is substantially perpendicular to the first side plate 15 and the second side plate 16.

The base 11 includes a first side surface 111 and a second side surface 112. Top plate 12 defines an opening 121. In one embodiment, the first side surface 111 is substantially perpendicular to the second side surface 112. The first side plate 15 defines a locking hole 151 and a first installation hole 153. A support plate 110 connects the first side plate 15 and the base 11. The second side plate 16 defines a second installation hole 161. The second installation hole 161 is aligned with the first installation hole 153. A sliding space 18 is defined by the rear plate 13, the first side plate 15, and the second side plate 16. In one embodiment, the base 11 is rectangular.

A bottom surface of the base 11 intersects the first side surface 111, at a first edge 115, and intersects the second side surface 112, at a second edge 116. An outer surface of the second side plate 16 is coplanar with the first side surface 111. An outer surface of the rear plate 13 is coplanar with the second side surface 112. The outer surface of the second side plate 16 intersects the outer surface of the rear plate 13 at a third edge 117. The first edge 115, the second edge 116, and the third edge 117 intersect at a first point O. The outer surface of the rear plate 13 designs a first set of scale lines. The first set of scale lines includes a plurality of first scale values. The first point O is an origin of the first set of scale lines. The plurality of first scale values increase gradually from bottom to top. The outer surface of the second side plate 16 designs a second set of scale lines. The second set of scale lines includes a plurality of second scale values. The first point O is an origin of the second set of scale lines. The plurality of second scale values increase gradually from bottom to top. A largest first scale value and a largest second scale value are N.

The sliding ruler 20 includes a rear wall 21, a top wall 22, a front wall 23 opposite to the rear wall 21, a first sidewall 25, and a second sidewall 26 opposite to the first sidewall 25. The top wall 22, the rear wall 21 and the second sidewall 26 intersect at a second point C. The first sidewall 25 defines a sliding slot 251. The sliding slot 251 extends to the top wall 22 and includes a limiting end 253. The front wall 23 defines a slot (not labeled). An extending direction of the slot is substantially perpendicular to the top wall 22. A plurality of teeth 231 are located in the slot. The second sidewall 26 designs a third set of scale lines. The third set of scale lines includes a plurality of third scale values. The second point C is an origin of the third set of scale lines. The rear wall 21 designs a fourth set of scale lines. The fourth set of scale lines includes a plurality of fourth scale values. The second point C is an origin of the fourth set of scale lines. A scale value corresponding to the second point C is N. Each of the plurality of third scale values and the plurality of fourth scale values increase gradually from top to bottom.

The securing assembly 30 includes a securing member 31 and a resilient member 32. The securing member 31 includes a securing portion 311, a blocking portion 312, and a ring-pull 313. The ring-pull 313 and the securing portion 311 are located on two opposite sides of the blocking portion 312. The securing portion 311 includes a plurality of outer threads. The ring-pull 313 can be used for conveniently operating the securing member 31. The resilient member 32 can slip over the securing portion 311. In one embodiment, the securing member 31 is a thumb screw, and the resilient member 32 is a spring.

The driving assembly 50 includes a handle 51 and a gear 53. The handle 51 includes an installation portion 511 and an operation portion 513. The installation portion 511 can be secured to the gear 53. The gear 53 defines a through hole 533 and a plurality of gear teeth 531.

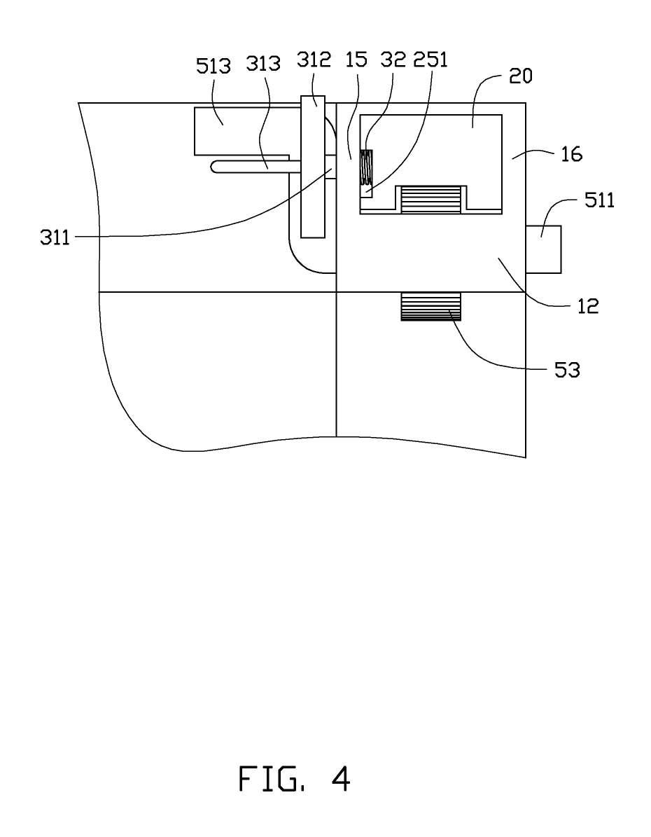

FIG. 4 shows that, in assembly, the sliding ruler 20 is moved towards the bracket, and a bottom end of the sliding ruler 20 is aligned with the bracket 10. The sliding ruler 20 is slid into the sliding space 18 through the opening 121. The gear 53 is positioned between the first side plate 15 and the second side plate 16 and geared with the teeth 231. The installation portion 511 is inserted through the first installation hole 153, the through hole 533 and the second installation hole 161, to secure the gear 53 to the bracket 10. The handle 51 is secured to the gear 53. The operation portion 513 is rotatable to rotate the gear 53. The resilient member 32 is positioned between the first sidewall 25 and the first side plate 15. A first end of the resilient member 32 is located in the sliding slot 251. The securing portion 311 is engaged in the locking hole 151. The resilient member 32 slips over the securing portion 311 and abuts the blocking portion 312. The securing member 31 is rotated towards the bracket 10 to elastically deform the resilient member 32. The resilient member 32 exerts elastic force to engage the sliding ruler 20 to the bracket 10 and prevent the sliding ruler from moving towards the first side plate 15.

In use, the base 11 of the bracket 10 is placed on a ground. The measuring device determines a plurality of positions, having different pre-setting distances from the ground. When the different pre-setting distances are smaller than or equal to the scale value N, the first set of scale lines and the second set of scale lines of the bracket 10 is capable of measuring the different pre-setting distances and determine the plurality of positions. When the different pre-setting distances are greater than the scale value N, the securing member 31 is rotated away from the first side plate 15, the resilient member 32 rebounds to release the sliding ruler 20. The gear 53 is rotated to slide upwards the sliding ruler 20, until the third scale value and the fourth scale value are equal to each pre-setting distance. The securing member 31 is rotated towards the first side plate 15, the resilient member 32 is elastically deformed to engage the sliding ruler 20 to the bracket 10. Thus, a distance between the top wall 22 and the ground is equal to the pre-setting distance. Thus, the point can be determined.

When the gear 53 is rotated to slide upwards the sliding ruler 20, the limiting end 253 abuts the securing portion 311, to prevent the sliding ruler 20 from sliding out of the bracket 10.

In one embodiment, the scale value N is 100 mm. Thus, users can look at the front horizontally at the scale values easily.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and the arrangement of parts within the principles of the disclosure, to the full extent indicated by the broad general meaning of the terms in which the appended claims are expressed.

What is claimed is:

1. A measuring device, comprising:
a bracket comprising a first set of scale lines;
a sliding ruler slidably attached to the bracket and comprising a second set of scale lines;
a securing assembly comprising a securing member and a resilient member mounted to the securing member; and
a driving assembly rotatably attached to the bracket and comprising a gear;
wherein the gear is rotatable to slide the sliding ruler relative to the bracket; the securing member is secured to the bracket, and the resilient member is secured between the sliding ruler and the bracket; the securing member is rotatable to elastically deform the resilient member to press the sliding ruler between the securing assembly and the bracket when the sliding ruler is located in a desired position.

2. The measuring device of claim 1, wherein the bracket further comprises a base, a top plate, a rear plate, a first side plate, and a second side plate opposite to the first side plate; and the top plate, the rear plate, the first side plate, and the second side plate together define a sliding space for receiving the sliding ruler.

3. The measuring device of claim 2, wherein the sliding ruler comprises a top wall, a rear wall, a front wall opposite to the rear wall, a first sidewall, and a second sidewall opposite to the first sidewall; the first sidewall faces the first side plate, the second sidewall faces the second side plate, and the rear wall faces the rear plate; and the top wall defines an opening for the sliding ruler sliding through.

4. The measuring device of claim 3, wherein the front wall defines a slot and comprises a plurality of teeth, and the plurality of teeth are located in the slot; the gear is received between the first side plate and the second side plate; the gear comprises a plurality of gear teeth, and the plurality of gear teeth are geared with the plurality of teeth.

5. The measuring device of claim 3, wherein the first set of scale lines is located on the second side plate and comprises a plurality of first scale values; the second set of scale lines is located on the second sidewall and comprises a plurality of second scale values; the plurality of first scale values increase gradually from the base, and the plurality of second scale values decrease gradually from the base.

6. The measuring device of claim 5, wherein the plurality of first scale values comprises a largest scale value, the plurality of second scale values comprises a smallest scale value, and the largest scale value is equal to the smallest scale value.

7. The measuring device of claim 6, wherein the second side plate and the rear plate are substantially perpendicular to the base, and the second side plate is substantially perpendicular to the rear plate; the second side plate, the rear plate, and a bottom surface of the base intersect at a point, and the point is an origin of the first set of scale lines; and a distance between the top plate and the bottom surface of the base is equal to the largest scale value.

8. The measuring device of claim 6, wherein the largest scale value is 100 mm.

9. The measuring device of claim 3, wherein when the sliding ruler is fully received in the sliding space, and the top wall is coplanar with the top plate.

10. The measuring device of claim 3, wherein the securing assembly is secured to the first side plate; the first side plate defines a sliding slot; a first end of the resilient member is received in the sliding slot, and a second end of the resilient member, opposite to the first end, is secured to the securing member.

11. A measuring device, comprising:
a bracket comprising a first set of scale lines comprising a plurality of first scale values;
a sliding ruler slidably attached to the bracket and comprising a second set of scale lines comprising a plurality of second scale values;
a securing assembly comprising a securing member and a resilient member mounted to the securing member; and
a driving assembly rotatably attached to the bracket and comprising a gear;
wherein the plurality of first scale values increase gradually from bottom to top, and the plurality of second scale values increase gradually from top to bottom; the gear is rotatable to slide the sliding ruler relative to the bracket; the securing member is secured to the bracket, and the resilient member is secured between the sliding ruler and the bracket; the securing member is rotatable to elastically deform the resilient member to press the sliding ruler between the securing assembly and the bracket when the sliding ruler is located in a desired position.

12. The measuring device of claim 11, wherein the bracket further comprises a base, a top plate, a rear plate, a first side plate, and a second side plate opposite to the first side plate; and the top plate, the rear plate, the first side plate, and the second side plate together define a sliding space for receiving the sliding ruler.

13. The measuring device of claim 12, wherein the sliding ruler comprises a top wall, a rear wall, a front wall opposite to the rear wall, a first sidewall, and a second sidewall opposite to the first sidewall; the first sidewall faces the first side plate, the second sidewall faces the second side plate, and the rear wall faces the rear plate; and the top wall defines an opening for the sliding ruler sliding through.

14. The measuring device of claim 13, wherein the front wall defines a slot and comprises a plurality of teeth, and the plurality of teeth are located in the slot; the gear is received between the first side plate and the second side plate; the gear comprises a plurality of gear teeth, and the plurality of gear teeth are geared with the plurality of teeth.

15. The measuring device of claim 13, wherein the first set of scale lines is located on the second side plate; the second set of scale lines is located on the second sidewall; the plurality of first scale values increase gradually from the base, and the plurality of second scale values decrease gradually from the base.

16. The measuring device of claim 15, wherein the plurality of first scale values comprises a largest scale value, the plurality of second scale values comprises a smallest scale value, and the largest scale value is equal to the smallest scale value.

17. The measuring device of claim 16, wherein the second side plate and the rear plate are substantially perpendicular to the base, and the second side plate is substantially perpendicular to the rear plate; the second side plate, the rear plate and a bottom surface of the base intersect at a point, and the point is an origin of the first set of scale lines; and a distance between the top plate and the bottom surface of the base is equal to the largest scale value.

18. The measuring device of claim 16, wherein the largest scale value is 100 mm.

19. The measuring device of claim 13, wherein when the sliding ruler is fully received in the sliding space, and the top wall is coplanar with the top plate.

20. The measuring device of claim 13, wherein the securing assembly is secured to the first side plate; the first side plate defines a sliding slot; a first end of the resilient member is received in the sliding slot, and a second end of the resilient member, opposite to the first end, is secured to the securing member.
